(19) United States
(12) Patent Application Publication
(10) Pub. No.: US 2025/0371401 A1
(43) Pub. Date: Dec. 4, 2025

(54) QUANTUM COMMUNICATION

(71) Applicant: Bank of America Corporation, Charlotte, NC (US)

(72) Inventors: Manu Kurian, Dallas, TX (US); Michael G. Horstman, Chicago, IL (US); Hugo Christopher Maxwell Beales, London (GB); Sasikumar Purushothaman, Frisco, TX (US); Jabir Mahammad, Tolichowki Hyderabad (IN)

(21) Appl. No.: 18/678,661

(22) Filed: May 30, 2024

(51) Int. Cl. G06N 10/60; G06Q 30/01

(52) U.S. Cl. CPC G06N 10/60; G06Q 30/01

(57) ABSTRACT

Apparatus for implementing a quantum communication system between an entity and a user includes collecting user-relevant historical data and current behavioral data with an artificial intelligence and/or machine learning module. One or more quantum computing processors may analyze and shrink the data into reduced datasets. One or more quantum algorithms may be used to shrink the data. The one or more quantum computing processors may create a plurality of contact points associated with the user that are based on the reduced datasets. A standard script associated with the interaction may be adjusted using the contact points. The adjusted script may be presented to an agent associated with the entity to conduct the interaction.

### FIELD OF TECHNOLOGY

Aspects of the disclosure relate to quantum computing and communication.

### BACKGROUND OF THE DISCLOSURE

Entities constantly and continuously interact with users across various electronic channels. The interactions are regarding a range of topics and have multiple purposes. Electronic communication channels include email, text, chat, telephone, interactive voice response (“IVR”) systems and/or other electronic communication channels. Topics of the communications include finance, education and any other suitable topics. The purposes of the communications include advertising, product sales, product resales, query responses, system assistance, technical assistance and/or a plurality of additional reasons.

Many times, these communications are standardized. As such, identical communications are transmitted to a plurality of users. Standardized communications are simple to generate. However, standardized communications do not provide the user with the information that is specifically relevant to the user.

Therefore, it would be desirable to provide a communication system that enables customized interactions between an entity and a user.

It would be further desirable for the communication system to be customized for each individual user.

It would be yet further desirable for the communication system to include a quantum processor. As such, the communication system may be a quantum communication system. The quantum communication system may implement communications that operate at higher than typical communication speeds.

It would be yet further desirable for the quantum communication system to collect user-relevant data. The user-relevant data may include a tone of voice, a plurality of words and a plurality of additional information relating to the user.

It would be yet further desirable for the quantum communication system to collect user-relevant data, such as the tone of voice, the plurality of words and the plurality of additional information to customize interactions with the user.

### SUMMARY OF THE DISCLOSURE

Apparatus, methods and systems for implementing a quantum communication system are provided.

A quantum communication system may include one or more quantum computing processors. The one or more quantum computing processors may collect a plurality of data elements. The one or more quantum computing processors may collect data elements from multiple sources. The data elements may be collected from entity-specific sources. The data elements may be collected from public sources. Public sources may include the internet and/or any other public source. Data elements collected from public sources may include information that can be shared, used, reused and/or redistributed without restriction. The data may be collected from private sources. Data collected from private sources may include personal, personally identifiable, financial, sensitive or regulated information relating to a specific person or entity.

The plurality of data elements may include behavioral data, user-relevant historical data, current behavioral data as well as other suitable data. For the purposes of this application, behavioral data may be understood to mean data relevant to activities of one or more of a plurality of users.

The collected data elements may include historical data elements. The historical data elements may include user-relevant historical data. The historical data elements may also include behavioral data relevant to the one or more users. The collected data elements may include current (real-time) data elements.

The behavioral data may include interactions that identify a tone of voice for one or more users included in the plurality of users. The behavioral data may also include interactions that include a choice of words from each of the users included in the plurality of users (i.e., a subset of words that occur over a predetermined frequency within interactions specific to a user). The behavioral data may also include historical interactions of a user in a system. The behavioral data may also include social media posts posted by one or more users. The behavioral data may also include any other data that is applicable to a user and/or a user's behavior.

For purposes of this application, user-relevant historical data may be understood to mean historical activities of the user and other data associated with the user. Other data associated with the user may include a username, a password, a social security number, a mobile telephone number and/or other suitable data. The user-relevant historical data may be retrieved from a previous interaction the user has had with the quantum communication system or any other interactive system conducted between an entity and a user.

During an interaction, an AI/ML module may collect current data elements. The current data elements may include user-specific behavioral data. For the purposes of this application, current behavioral data may be understood to mean behavioral data retrieved in real-time, during an interaction between a user and an entity. Current behavioral data may include a voice level, an emotion level, a pause in a conversation greater than or equal to a predetermined amount of time, word usage as well as other behavioral data captured during the interaction. The current data may be used to prepare responses that are appropriate for the current interaction.

In certain embodiments, an interaction using the quantum communication system may include a user and an agent. The agent may be a human agent. The agent may be a digital agent. The agent may be any suitable agent. The agent may inform the user that the user is no longer eligible to receive a service. The user may begin expressing a negative sentiment. Therefore, the user's tone of voice may increase. In response to detecting a tone of voice change, the quantum communication system may receive current behavioral data about the user. The quantum communication system may collect the current behavioral data, with use of one or more AI/ML modules.

The quantum communication system may analyze the data. The data may be analyzed using one or more quantum computing processors. Analyzing the data may include identifying users located within the data, identifying the type of data received. Examples of data received may include Portable Document Format (.pdf), .xlsx and .doc. Analyzing may include other analyses as well. The data may be analyzed as applicable to more than one user. The quantum communication system may organize data by user. Analyzing the data may be a scalable analysis in which each user is analyzed.

The quantum communication system may further shrink the data elements. The one or more quantum computing processors may shrink the analyzed data into one or more reduced datasets. Shrinking the analyzed data elements may reduce the data to data relevant for a specific subset of users. The data may be reduced relevancy-wise. Data that is identified as relevant over a threshold of relevancy may be removed during shrinking. The data may be reduced size-wise. Data that is identified as relevant over a threshold of size may be removed during shrinking. Reducing the data may result in data relevant to the one or more users.

In certain embodiments, the quantum communication system may include one or more quantum algorithms to shrink the datasets. The quantum algorithm may be an algorithm that converts an audio file and/or a voice file into a text file (also referred to as a speech-to-text algorithm). The speech-to text algorithm may identify a series of parameters from the converted audio file. The quantum algorithm may be an algorithm that converts a video file into a text file and identifies a series of parameters from the video file. The quantum algorithm may be any other suitable algorithm.

Shrinking the datasets may include converting an audio file into a text file. An audio file may be larger than a text file. The user-relevant historical data may include an audio file of an interaction between an entity and the user. The entity may be the entity associated with the quantum computing system. The entity may be an entity that is not associated with the quantum computing system. Converting the audio file may include retrieving a series of parameters from the audio file. The series of parameters may include a tone of voice, usage of a plurality of predetermined words, timestamps at which a voice was raised and/or lowered, pauses within the interaction as well as a plurality of other parameters. There may be a series of parameters and a text file of the interaction retrieved. The series of parameters and/or the text file may be the reduced datasets.

The quantum communication system may further include creating a plurality of contact points (i.e., communication parameters). Examples of communication parameters may include a time of day a user prefers to conduct a call, a hobby, a set of background information, a location, a place of residency and/or additional contact points.

The plurality of contact points may be based on the reduced datasets. The plurality of contact points may be associated with the user. Data about the user during previous and/or current interactions may have been retrieved. In certain embodiments utilizing quantum communication, a single one of the plurality of contact points may correspond to an up-spin of a qubit, a single one of the plurality of points corresponding to a down-spin of the qubit and at least one of the plurality of points corresponding to a superposition of the up-spin of the qubit and the down-spin of the qubit. In this way, the speed of the qubit processing may be leveraged to more quickly process the information associated with the contact points.

During current and/or previous interactions, a user may have associated a topic with a positive sentiment over a predetermined threshold of positivity. A predetermined threshold of positivity may include laughing over a predetermined threshold of time and/or any other possible predetermined levels of positivity. The topic associated with the positive sentiment over a predetermined threshold of positivity may be recorded as a positive preference. Contact points may include points that a system should refrain from approaching during an interaction with the user.

The contact points may enable generating a customized interaction for both the entity and the user. The entity may contact the user, based on the contact points, at a time preferable to the user (e.g., in the morning when the user is unoccupied). Contact points and background information may have been created using the reduced datasets and/or the additional data.

The quantum computing processors may adjust scripts associated with one or more interactions based on the contact points. There may be a basic script the entity uses when interacting with a user. The script may be adjusted, using the one or more quantum computing processors, according to the contact points associated with the user. In this way, the interaction may be customized for the specific user. The entity may use the adjusted script to interact with the user.

The quantum communication system may further present the adjusted script to an agent conducting the interaction. The adjusted script may be used during the interaction, in an interactive manner.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows an illustrative flow diagram in accordance with the principles of the disclosure;

FIG. 4 shows another illustrative flow diagram in accordance with the principles of the disclosure;

FIG. 5 shows still another illustrative flow diagram in accordance with the principles of the disclosure;

FIG. 6 shows an illustrative diagram in accordance with the principles of the disclosure; and

FIG. 7 shows another illustrative diagram in accordance with the principles of the disclosure.

### DETAILED DESCRIPTION OF THE DISCLOSURE

Apparatus, methods and systems for implementing a quantum communication system is provided.

Methods may implement a quantum communication system to provide interactions between an entity and a user. Methods may include collecting a plurality of data elements. An artificial intelligence and/or machine learning (“AI/ML”) module may collect the plurality of data elements. The data elements may be collected from entity-specific sources. The data elements may be collected from public sources. Public sources may include the internet and/or any other public source. Data elements collected from public sources may include information that can be shared, used, reused, and/or redistributed without restriction. The data may be collected from private sources. Data collected from private sources may include personal, personally identifiable, financial, sensitive or regulated information relating to a specific person or entity.

The plurality of data elements may include behavioral data, user relevant historical data, current behavioral data as well as other suitable data. For the purposes of this application, behavioral data may be understood to mean data relevant to activities of one or more of a plurality of users.

The collected data elements may include historical data elements. The historical data elements may include user relevant historical data. The collected historical data elements may also include behavioral data relevant to the one or more users. The collected data elements may include current (real-time) data elements. The data elements may include any other suitable data.

The behavioral data may include interactions that identify a tone of voice for one or more users included in the plurality of users. The behavioral data may also include interactions that include a choice of words from each of the users included in the plurality of users (i.e., a subset of words that occur over a predetermined frequency within interactions to a specific user). The behavioral data may also include historical interactions of a user in a system. The behavioral data may also include social media posts posted by one or more users. The behavioral data may also include any other data that is applicable to a user and/or a user's behavior.

Behavioral data may be data relevant to one or more users. Behavioral data may include data retrieved in real-time, during an interaction between the user and the entity. Behavioral data retrieved in real-time may be referred to as current behavioral data. One or more quantum computing processors may retrieve data about the user as the user interacts with the entity.

User-relevant historical data may be understood to mean historical activities of the user, historical behavioral data about the user and other data elements associated with the user. Other data associated with the user may include a username, a password, a social security number, a mobile telephone number and/or other suitable data. The user-relevant historical data may be retrieved from a previous interaction the user has had with the quantum communication system and/or any other interaction conducted between a user and an entity.

Methods may further include analyzing the data elements. The data elements may be analyzed using the one or more quantum computing processors. The data elements may be analyzed to identify the data elements. Analyzing the data elements may include identifying users located with the data elements, identifying the type of data received. Examples of data received may include a .pdf, .xlsx, .doc and any other suitable data. Analyzing the data elements may include any other analyses. The data elements may include data elements about more than one user. The quantum computing processors may organize the data elements by user. Analyzing the data may be a scalable analysis in which each user is analyzed.

Methods may further include shrinking the data elements. The one or more quantum communication processors may shrink the data elements. The quantum computing processors may shrink the data elements into reduced datasets. The quantum computing processors may reduce the data elements relevancy-wise to data relevant for a specific subset of users. Data elements that are identified as greater than a threshold of relevancy may be removed during shrinking. A threshold of relevancy may include a number of users included in the system over a predetermined threshold of numbers. The quantum computing processors may reduce the data size-wise. Data that is identified over a threshold of size may be reduced into a smaller size dataset. The size of a dataset may be reduced by converting an audio file into a text file, while retrieving parameters associated with the audio file.

In certain embodiments, the quantum communication system may include one or more quantum algorithms to shrink the data elements. The quantum algorithm may be an algorithm that converts an audio file into a text file (or a speech-to-text algorithm). The quantum computing processor may convert the audio file into a text file while retrieving a series of parameters associated with the audio file.

A series of parameters may be a tone of voice, a usage of a plurality of predetermined words, timestamps at which a voice was raised and/or lowered, pauses within the interaction as well as a plurality of other parameters. There may be a series of parameters and a text file converted from the interaction. The series of parameters and/or the text file may be the reduced datasets.

Methods may further include creating contact points (i.e., communication parameters) based on the reduced datasets. There may be a plurality of contact points created based on the datasets. The contact points may be associated with the user. The contact points may be different for each user. The contact points may be the same for each user.

Contact points may include a set of background information, a hobby, a communication mode, a time of day to conduct a call, a location and/or a plurality of additional information relevant to the user.

Methods may further include adjusting interactions with the user based on the contact points. There may be a standard script the entity uses to interact with users. The standard script may be adjusted to each user based on the contact points.

Methods may further include presenting the adjusted script to an agent conducting the interaction. The agent may conduct the quantum communication system interaction based on the adjusted script.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of the selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer readable data structures.

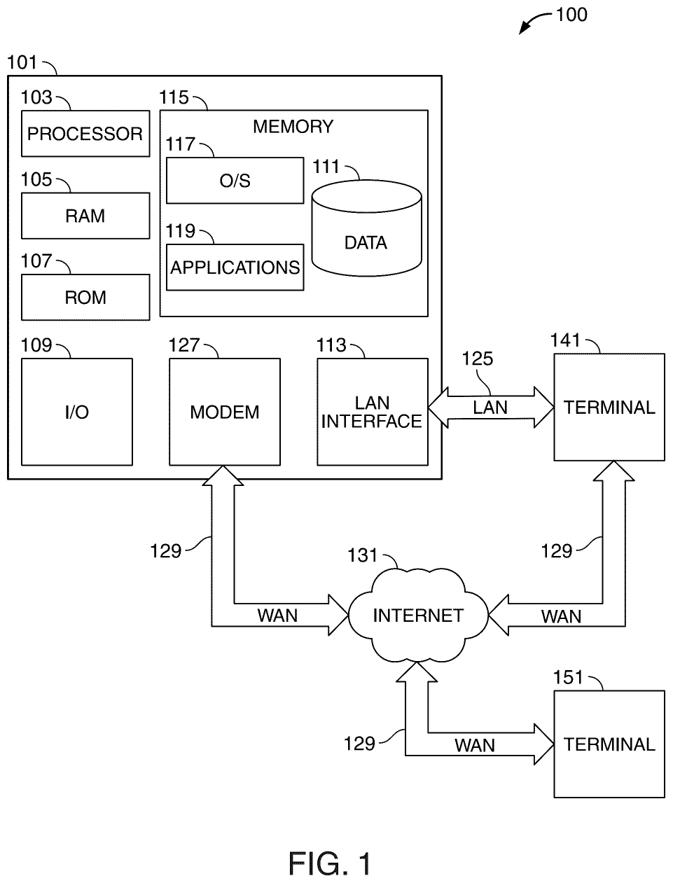

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related to performing various tasks. The various tasks may be related to interactive IVR hubs. It should be noted that, for the purposes of this application, IVR architecture and/or IVR hubs and/or IVR should be understood to refer to an intelligent front-end/back-end system that aids an agent and/or entity in responding to customer requests.

Computer 101 and/or terminals 141 and 151 may also be devices including various other components, such as a battery, speaker, and/or antennas (not shown).

Terminal 151 and/or terminal 111 may be portable devices such as a laptop, cell phone, Blackberry™, tablet, smartphone, or any other suitable device for receiving, storing, transmitting and/or displaying relevant information. Terminals 151 and/or terminal 111 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. It should be noted that such modules may be considered, for the purposes of this application, as engines with respect to the performance of the particular tasks to which the modules are assigned.

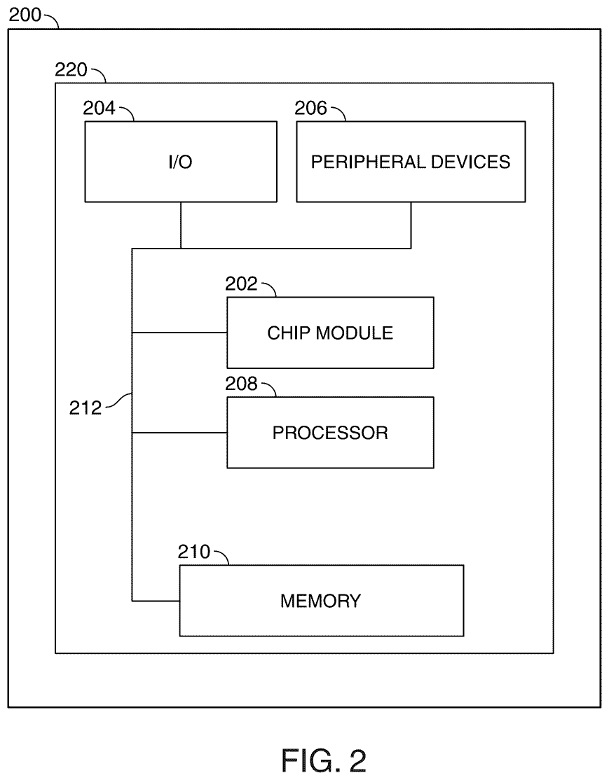

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

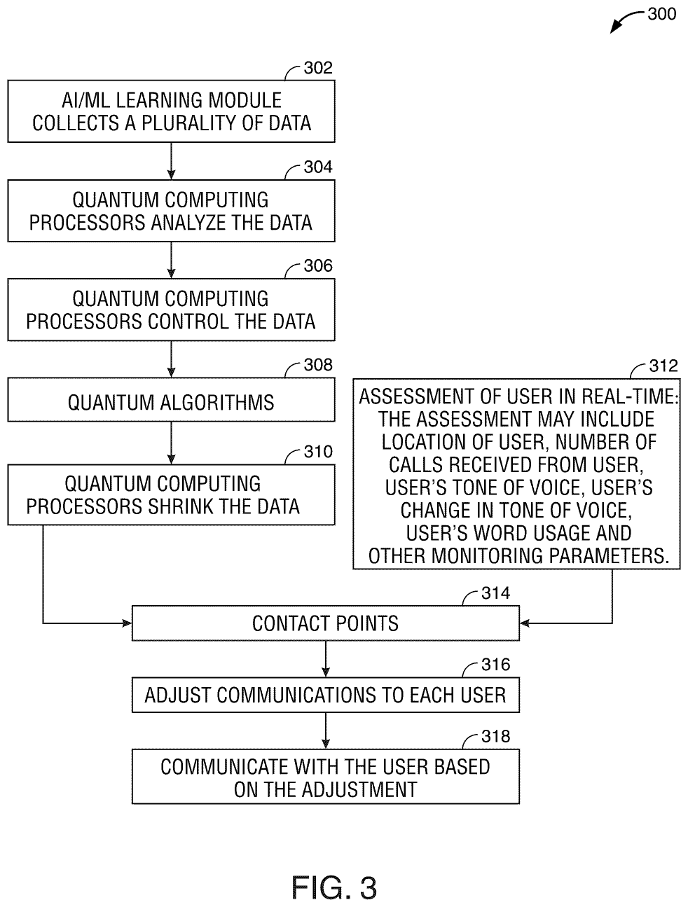

FIG. 3 shows an illustrative flow diagram. Diagram 300 shows the process of implementing a quantum communication system in an interaction between a user and an entity. Data may be collected using an artificial intelligence machine learning (“AI/ML”) module, as shown at 302. The data collected by the AI/ML module may be user-relevant historical data, current behavioral data and/or other data relevant to users.

There may be one or more quantum computing processors included in the quantum communication system. The quantum computing processors may analyze the data, as shown at step 304. The data may be analyzed to find data most relevant to the user involved in the interaction. The data may be analyzed and the quantum computing processors may determine datasets that are applicable to the quantum communication system. It should be noted that there may be unique datasets determined to be applicable to the quantum communication system during use of the system.

The quantum computing processors may control the collected data. The data may or may not be controlled. The data may be encrypted. The one or more quantum computing processors may decrypt the data. The quantum computing processors may control the data by mitigating the data. The quantum computing processors may control the data to increase efficiency in the quantum communication system.

Shrinking the data may be executed after the data is analyzed and controlled. Shrinking the data may include shrinking the data size-wise and relevancy-wise. Shrinking the data size-wise may result in reduced datasets. Shrinking the data relevancy-wise may include shrinking the data to include data applicable to predetermined interactions.

There may be one or more quantum algorithms that are used in the quantum communication system, as shown at step 310. The quantum algorithms (shown at 308) may be used to shrink the data into reduced datasets. The quantum algorithms may convert audio files into text files and/or a series of parameters. The quantum algorithms may convert video files into text files and/or a series of parameters. The quantum algorithms may perform a plurality of operations.

Step 308 shows the quantum algorithms which may be used to reduce the datasets. The datasets may be reduced size-wise. The datasets may be reduced relevancy-wise. The datasets may be reduced size-wise to include datasets under a predetermined threshold of size. The datasets may be reduced relevancy-wise to include data under a predetermined level of relevancy. A predetermined level of relevancy may be a unique number of users included in the datasets.

Step 312 shows a real time assessment of the user during the quantum communication system interaction. The user may be assessed to determine the location of the user, the number of calls received from the user, a tone of voice, a change in the tone of voice, the point at which the tone of voice is changes, a plurality of predetermined word usage, and/or other monitoring parameters.

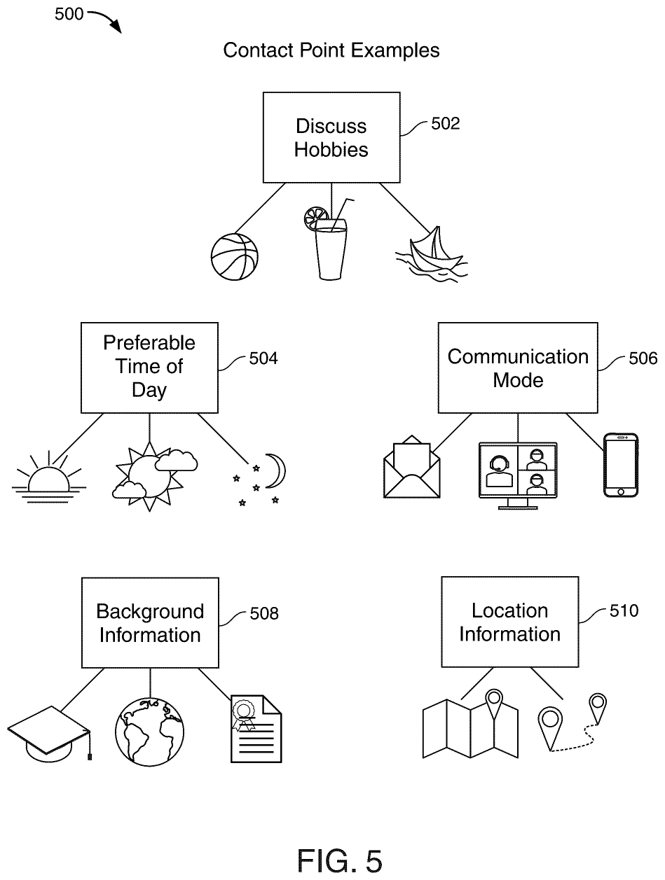

Step 314 shows the contact points created using the one or more quantum computing processors based on the reduced datasets and the assessment of the data. The contact points may modify the interactions to produce customized and efficient interactions between the entity and users. Examples of contact points may include a time day a user prefers to conduct a call, at least one hobby, a mode of communication that a user may prefer when conducting a call, a set of background information about a user, a location as well as other information that may be beneficial to the entity when interacting the with user. The contact points are shown in more detail in FIG. 5 and described in the portion of the specification corresponding thereto.

Communications between the entity and the user may be adjusted, as shown in step 316. There may be a standard script for each reason an entity may contact a user. The standard script may be adjusted and customized for each user according to the contact points. The entity may interact with the user based on the adjustment, as shown at step 318.

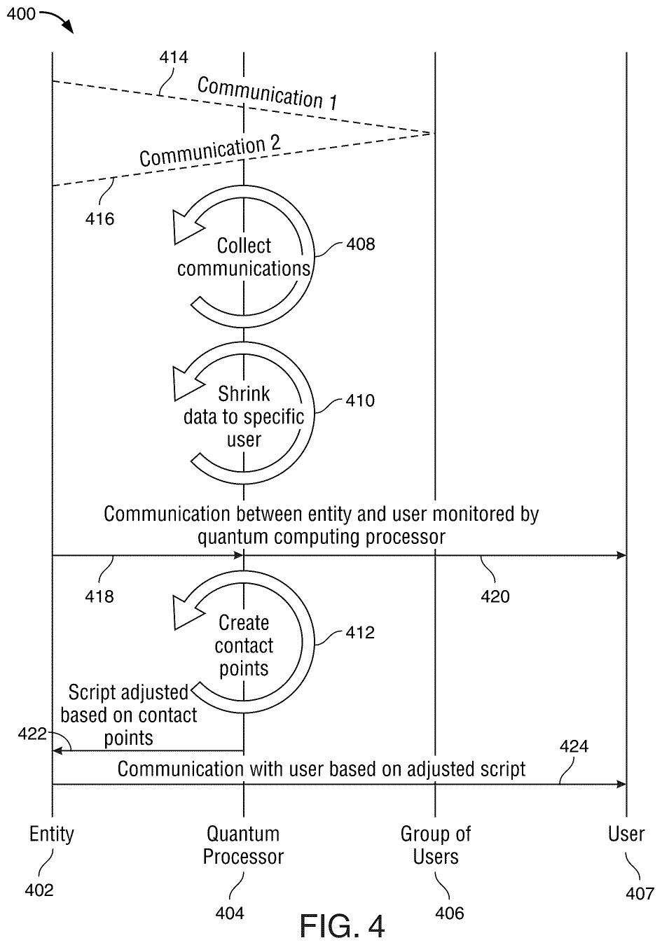

FIG. 4 shows an illustrative diagram. Diagram 400 shows the quantum communication system. The quantum communication system includes an entity 402, one or more quantum computing processors 404, a group of users 406 and user 407. User 407 may have been selected from among the group of users 406.

There may be a first communication between entity 402 and group of users 406. The first communication may be shown at 414. Communication 414 may be a phone communication, an email communication, a video conference and/or any other suitable communication. Entity 402 may communicate with each user from among group of users 406. Quantum processors 404 may record communication 414 between entity 402 and group of users 406.

Entity 402 may communicate one or more subsequent instances with group of users 406. Communication 2, shown at 416, may indicate the one or more subsequent communications. Communication 416 may be a phone communication, a chat communication, an email communication, a video conference and/or any other suitable communications. Quantum processor 404 may record communication 416.

Quantum processor 404 may collect the data from communication 414 and communication 416, as shown at step 408. Quantum processor 404 may shrink the collected data as shown at step 410. Quantum processors 404 may shrink the collected data to produce reduced datasets. The datasets may be reduced as applicable to a specific user. The specific user may be user 407.

Entity 402 may interact with user 407 using the quantum communication system. Entity 402 may initiate an additional communication with user 407, as shown at steps 418 and 420. Quantum processor 404 may monitor the additional communication between entity 402 and user 407.

Quantum processor 404 may create contact points, as shown at step 412. The contact points may be based upon the reduced datasets and the monitored communication. The contact points may be individual for each user. A user may have different contact points than another user.

Quantum processor 404 may send the contact points to entity 402, as shown at step 422. Quantum processor 404 may adjust a standard interaction script to accommodate the contact points and to provide entity 402 and user 407 with a customized and efficient interaction, as shown at step 424. Entity 402 may communicate with user 407 using the adjusted interaction script.

The adjusted interaction script may be presented to an agent associated with the entity. The agent associated with the entity may be an agent conducting the interaction. The agent may conduct the interaction using the adjusted interaction script.

FIG. 5 shows another illustrative diagram. Diagram 500 is a diagram of contact point examples or communication parameters. The examples include 502, 504, 506, 508 and 510. Example 502 may be hobbies. The interaction between the user and the entity may include discussing hobbies. Hobbies may include sports, activities and/or sitting in the sun. Another example may include example 504. Example 504 is a time of day a user prefers to conduct a call with the user. The user may prefer morning interactions, noontime interactions or interactions during any other time of day.

An additional example may be example 506. Example 506 is a communication mode. Some users may prefer video conferences over email interactions. Other users may prefer phone interactions. Based on the past interactions, the contact points may provide the entity with the most desirable communication for the user.

Another example may be example 508. Example 508 may be background information. The background information may be about the user. The background information may include a degree belonging to the user, an alma mater of the user and/or other suitable background information. The background information may include work relevant information as well as other information retrieved from previous communications between the user and the entity.

Still yet another example may be example 510. Example 510 may be location information. The location information may be about the user. The user may be located within a city; the user may be located within a suburb; and/or the user may be located within a plurality of distinct locations. The locations may be retrieved with the contact points, based on previous interactions.

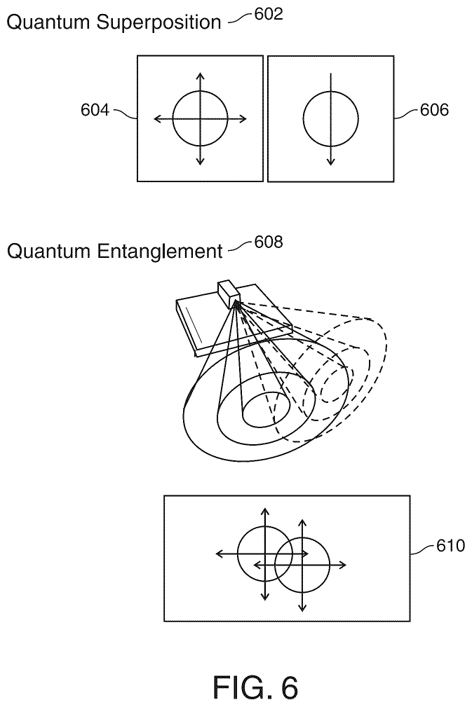

FIG. 6 shows an illustrative diagram. The illustrative diagram shows components of quantum technology. Because quantum technology behaves differently from classical technology, quantum technology provides additional facets to computing. While storage and computing capacity of classical computing grows in a linear fashion, storage and computing capacity of quantum computing grows in an exponential fashion.

Quantum technology may rely on properties of quantum mechanics, such as, for example, quantum superposition, quantum entanglement, quantum tunnelling and quantum interference.

Quantum superposition, shown at 602, states that an unobserved quantum particle, such as a photon, exists in all possible states (spin-up state, a spin-down state or any probability of a spin-up state and spin-down state) simultaneously, as shown at 604. However, when a quantum particle is observed or measured, the quantum particle collapses into a single state, such as a spin-down state, as shown at 606.

Quantum entanglement, shown at 608, states that quantum particles may become connected with one another. The entangled particles correlate with each other, as shown at 610. As such, even when the entangled particles are physically far apart, measuring the state of one of the entangled particles reveals the state of the other entangled particle.

A laser beam fired through a certain type of crystal can cause individual photons to be split into pairs of entangled photons. A pair of entangled photons may be shown at 608.

Quantum tunnelling states that a quantum particle may pass through a potential energy barrier that, according to classical physics, should not be passable due to the object not having sufficient energy to pass or surmount the barrier.

Quantum interference states that a quantum particle may interface with and/or influence itself and/or other particles while in a superposition state. Quantum interference can influence the probability of the state of the particle when the quantum particle is measured.

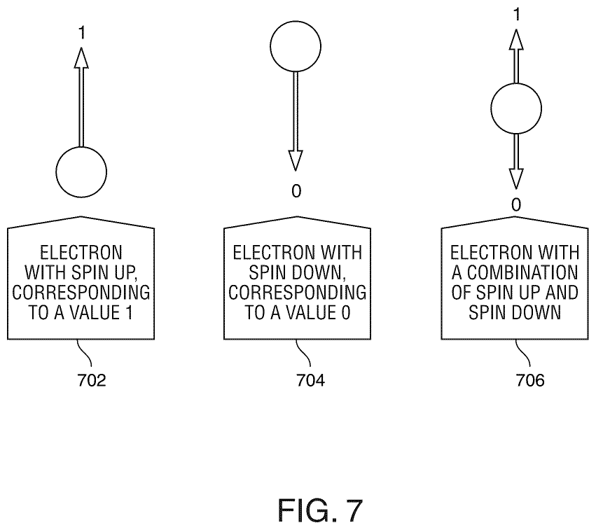

FIG. 7 shows an illustrative diagram. The illustrative diagram shows multiple electrons. A first electron, shown at 702, shows a spin-up, which may correspond, within a quantum processor, to a value of one. A second electron, shown at 704, shows a spin-down, which may correspond, within a quantum processor, to a value of zero. A third electron, shown at 706, shows a combination of a spin-up and a spin-down, which may correspond, within a quantum processor, to a value of both one and zero. A combination state of both spin-up and spin-down may be referred to as superposition.

Thus, a quantum communication system is provided. Persons skilled in the art will appreciate that the present invention can be practiced by other than the described embodiments, which are presented for purposes of illustration rather than of limitation. The present invention is limited only by the claims that follow.

What is claimed is:

1. A method for implementing a quantum communication system, said implementing the quantum communication system to provide interactions between an entity and a user based on quantum computing, said method comprising;
collecting, using an artificial intelligence machine learning (“AI/ML”) module, a plurality of data, the plurality of data including:
user-relevant historical data; and
current behavioral data;
analyzing, using one or more quantum computing processors, the collected data, said analyzing finding data most relevant to the user;
shrinking, using one or more quantum computing processors, the data into smaller datasets;
relevancy-wise; and
size-wise;
the shrinking includes using a quantum algorithm to:
convert an audio data into a text file;
retrieve a series of parameters based on the audio data;
creating, using the one or more quantum computing processors, a plurality of contact points, the plurality of contact points being associated with the user, a single one of the plurality of points corresponding to an up-spin, a single one of the plurality of points corresponding to a down-spin and at least one of the plurality of points corresponding to a superposition of the up-spin and the down-spin;
adjusting interactions between the entity and the user based on the contact points; and
presenting the adjusted script to an agent associated with the entity and the quantum communication system to conduct an interaction.

2. The method of claim 1 wherein the plurality of data is collected from multiple sources, the multiple sources including:
private sources; and
public sources.

3. The method of claim 1 wherein the user-relevant historical data includes a plurality of previous interactions.

4. The method of claim 1 wherein the current behavioral data includes current interactions with the user.

5. The method of claim 1 wherein shrinking the data relevancy-wise includes shrinking the data into data applicable to a specific user.

6. The method of claim 1 wherein the contact points include:
a plurality of hobbies associated with the user;
a time preferable to conduct a call; and
a location associated with the user.

7. The method of claim 1 wherein the one or more quantum computing processors create one or more quantum algorithms.

8. Apparatus for implementing a quantum communication system, said implementing a quantum communication system to provide interactions between an entity and a user based on quantum computing, said apparatus comprising;
user-relevant historical data;
current behavioral data;
an artificial intelligence machine learning (“AI/ML”) module, the AI/ML module operable to collect the user-relevant historical data and current behavioral data;
one or more quantum computing processors, the one or more quantum computing processors operable to:
analyze the user-relevant historical data and the current behavioral data, said analyze finding data most relevant to the user associated with the interaction; and
shrink the user-relevant historical data and the current behavioral data into smaller datasets, said shrinking relevancy-wise and size-wise;
the shrinking comprising using a plurality of quantum algorithms to:
convert an audio file into a text file; and
retrieve a series of parameters based on the audio file;
a plurality of contact points, the plurality of contact points being created using the one or more quantum computing processors, the plurality of contact points being associated with the user, a single one of the plurality of points corresponding to an up-spin, a single one of the plurality of points corresponding to a down-spin and at least one of the plurality of points corresponding to a superposition of the up-spin and the down-spin;
adjusting interactions between the entity and the user based on the contact points; and
presenting the interactions to an agent associated with the entity and the quantum computing system, said agent conducting the interaction.

9. The apparatus of claim 8 wherein the plurality of data is collected from multiple sources, the multiple sources including:
private sources; and
public sources.

10. The apparatus of claim 8 wherein the user-relevant historical data includes a plurality of previous interactions.

11. The apparatus of claim 8 wherein the current behavioral data includes current interactions with the user.

12. The apparatus of claim 8 wherein shrinking the data relevancy-wise includes shrinking into datasets applicable to a single user.

13. The apparatus of claim 8 wherein the contact points include:
a plurality of hobbies associated with the user;
a time preferable to conduct the interaction; and
a location associated with the user.

14. A quantum communication system, the quantum communication system comprising:
a collection of data, said data including user-relevant historical data and current behavioral data, the collection of data being performed using one or more quantum computing processors;
the one or more quantum computing processors further operable to:
analyze the collected data, said analyzing finding data most relevant to the user associated with the interaction; and
shrink the data into smaller datasets, said shrinking relevancy-wise and size-wise, wherein the shrinking comprises using one or more quantum algorithms to:
convert an audio file into a text file; and
retrieve a series of parameters from the audio file;
create a plurality of quantum algorithms, the plurality of quantum algorithms for converting the audio file into a text file and a series of parameters;
create a plurality of contact points, said contact points based on the converted data, the contact points being associated with a user, a single one of the plurality of points corresponding to an up-spin, a single one of the plurality of points corresponding to a down-spin and at least one of the plurality of points corresponding to a superposition of the up-spin and the down-spin;
adjust interactions between the entity and the user based on the contact points; and
present the adjusted script to an agent using the quantum communication system for an interaction with a user.

15. The system of claim 14 wherein the plurality of data is collected from multiple sources, the multiple sources including;
private sources; and
public sources.

16. The system of claim 14 wherein the user-relevant historical data includes a plurality of previous interactions.

17. The system of claim 14 wherein the behavioral data includes current interactions with the user.

18. The system of claim 14 wherein shrinking the data relevancy-wise includes shrinking the data for a single user.

19. The system of claim 14 wherein the contact points include:
a plurality of hobbies associated with the user;
a time preferable to conduct the call; and
a location associated with the user.
